(19) United States
(12) Patent Application Publication
(10) Pub. No.: US 2026/0081363 A1
(43) Pub. Date: Mar. 19, 2026

(54) TIN-BASED SOLDER PASTE, SOLDERING METHOD AND ELECTRONIC COMPONENT USING SAME

(71) Applicant: Cyntec Co., Ltd., Hsinchu (TW)

(72) Inventors: Yu-Ching Fang, Hsinchu (TW); Chia Cheng Chuang, Hsinchu (TW)

(21) Appl. No.: 19/214,575

(22) Filed: May 21, 2025

Related U.S. Application Data
(60) Provisional application No. 63/650,274, filed on May 21, 2024.

(51) Int. Cl. H01R 4/02; B23K 1/19; B23K 35/00; B23K 35/26; H01F 5/04; H01R 43/02

(52) U.S. Cl. CPC H01R 4/024; B23K 1/19; B23K 35/007; B23K 35/262; H01F 5/04; H01R 43/0235

(57) ABSTRACT

A tin-based solder paste, a soldering method and an electronic component formed thereby are provided. A copper powder is mixed into the tin-based solder paste, and a weight ratio of the copper powder to an overall metallic powder ranges within 0.2-20%. The electronic component includes a core element, a copper wire and a soldering member. The core element has thereon an electrode terminal. One end of the copper wire is in contact with the electrode terminal. The soldering member covers the one end of the copper wire and the electrode terminal to form the solder joint electrically connecting the copper wire to the electrode terminal, wherein copper-based particles enveloped in an intermetallic compound are dispersed in the soldering member, and the copper-based particles have a particle size of 1-50 μm.

### CROSS-REFERENCE TO RELATED APPLICATIONS

The present application is a nonprovisional application claiming benefit from a prior-filed provisional application bearing a Ser. No. 63/650,274 and filed May 21, 2024, the entity of which is incorporated herein for reference.

### FIELD OF THE INVENTION

The present disclosure relates to a tin-based solder paste and a related soldering method, and particularly to an electronic component using the tin-based solder paste and the soldering method for soldering a copper wire on an electrode terminal of the electronic component.

### BACKGROUND OF THE INVENTION

Reflow soldering is a widely used method of attaching components. For example, to establish an electrical connection between a wire and an electrode terminal, solder paste is first applied to the stripped portion of the wire and the electrode terminal. Then, the connection interface is gradually heated under a controlled temperature profile to melt the solder in the solder paste so as to uniformly cover both the wire and the electrode terminal. Afterwards, the solder is cooled and solidified to form a permanent solder joint firmly bonding the wire to the electrode terminal, thereby providing electrical conduction between them. The reflow soldering has the advantage of low assembly cost.

Please refer to FIGS. 1A and 1B, which are cross-sectional views illustrating the solder joint and the wire in the reflow soldering process. In the embodiment, the wire is a copper wire or a magnet copper wire, soldered using a common lead-free solder paste (e.g. SAC305 or SAC307). It is shown that a tin base 110 covers the copper wire 120 and its insulation layer 125. In FIG. 1A, with increasing temperature during the reflow soldering process, heterogeneous metal-metal bonds are gradually formed at the interface between the copper wire 120 and the tin base 110 to form a Cu₆Sn₅ intermetallic compound (IMC) layer 131. The initially formed Cu₆Sn₅ IMC has scallop structure and good bonding force, thus enhancing the soldering strength. The Cu₆Sn₅ IMC layer 131 continues to grow in thickness with increasing heating time and temperature. Subsequently, the Cu₆Sn₅ IMC further receives copper atoms from the copper wire 120 to form a Cu₃Sn IMC layer 132 between the Cu₆Sn₅ IMC layer 131 and the copper wire 120. The transformation from the Cu₆Sn₅ IMC to the Cu₃Sn IMC is accompanied by approximately 4.39% volume shrinkage. Therefore, Kirkendall voids are formed within the Cu₃Sn IMC layer 132.

During the reflow soldering process, the copper particles of the copper wire 20 continuously dissolve and diffuse into the tin base 110 until the tin base 110 is saturated with copper or the copper wire 120 covered by the tin base 110 is completely dissolved and depleted. For example, the initial copper concentration in SAC305 solder paste is 0.5%, and the saturation concentration of copper in molten tin is 1.75% (at temperature below 265° C.). Therefore, the copper wire 120 will gradually dissolve into the tin base 110 during the reflow soldering process, and the wire diameter progressively decreases, as shown in FIG. 1B. The reduction of the cross-sectional area lowers the electrical conductance of the copper wire 120. If the volume of the covered copper wire 120 is much smaller than that of the tin base 110, it may even eat through the copper wire 120 after several reflow soldering cycles. It seriously reduces the mechanical strength of the copper wire 120 and has the risk of wire breakage in practical applications.

### SUMMARY OF THE INVENTION

The present disclosure provides an electronic component having at least one solder joint. The electronic component includes a core element, a copper wire and a soldering member. The core element has thereon an electrode terminal. An end portion of the copper wire is in contact with the electrode terminal. The soldering member covers the end portion of the copper wire and the electrode terminal to form the solder joint electrically connecting the copper wire to the electrode terminal. Copper powder particles enveloped in an intermetallic compound are distributed within the soldering member, and the copper powder particles have a particle size ranging from 1 μm to 50 μm.

In an embodiment, a volume concentration of the copper powder particles in the soldering member is within a range of 0.1% to 35%.

In an embodiment, the soldering member is formed by a reflow soldering process, including melting a copper-added tin-based solder paste covering the end portion of the copper wire and the electrode terminal of the core element, and cooling the copper-added tin-based solder paste to form the soldering member. The copper-added tin-based solder paste includes a tin alloy powder and a copper powder mixed in a flux.

In an embodiment, the copper-added tin-based solder paste has a copper powder ratio of 0.2% to 20%, and the copper powder ratio is defined as

$$\frac{copper powder weight}{copper powder weight + tin alloy powder weight} .$$

In an embodiment, the tin alloy powder includes more than 40 wt % of tin.

In an embodiment, the intermetallic compound enveloping the copper powder particles includes Cu₆Sn₅ or Cu₃Sn.

In an embodiment, an intermetallic compound layer is formed between the copper wire and the soldering member to inhibit the copper wire from dissolving in the soldering member. The intermetallic compound layer comprises Cu₆Sn₅ or Cu₃Sn.

In an embodiment, the electronic component is a coil component, the copper wire is a copper coil wound around the core element, the electrode terminal includes a clamping part for clamping an end portion of the copper coil, and the soldering member covers the clamping part of the electrode terminal and a clamped portion of the copper coil.

The present disclosure further provides a copper-added tin-based solder paste, including a tin alloy powder; a copper powder; and a flux. A copper powder ratio is within a range of 0.2% to 20%, and the copper powder ratio is defined as:

$$\frac{copper powder weight}{copper powder weight + tin alloy powder weight} .$$

In an embodiment, the composition of the tin alloy powder includes silver, lead, bismuth, antimony, nickel, gold or copper.

In an embodiment, the copper powder has a particle size D₅₀ ranging from 1 μm to 50 μm.

In an embodiment, the copper-added tin-based solder paste has a melting point in a range of 130° C. to 230° C.

The present disclosure further provides a soldering method for soldering a copper wire to an electronic component, including steps of: providing a solder paste formed by suspending a tin alloy powder in a flux; mixing a copper powder into the solder paste to form a copper-added tin-based solder paste; and using the copper-added tin-based solder paste to solder an end portion of the copper wire to an electrode terminal of the electronic component by a reflow soldering process to form a soldering member covering the end portion of the copper wire and the electrode terminal, thereby forming a solder joint electrically connecting the copper wire and the electrode terminal in the electronic component, The copper-added tin-based solder paste has a copper powder ratio of 0.2% to 20%, and the copper powder ratio is defined as:

$$\frac{copper powder weight}{copper powder weight + tin alloy powder weight} .$$

### BRIEF DESCRIPTION OF THE DRAWINGS

The advantages of the present disclosure will become more readily apparent to those ordinarily skilled in the art after reviewing the following detailed description and accompanying drawings, in which:

FIGS. 1A and 1B are cross-sectional views illustrating the solder joint and the copper wire in the reflow soldering process.

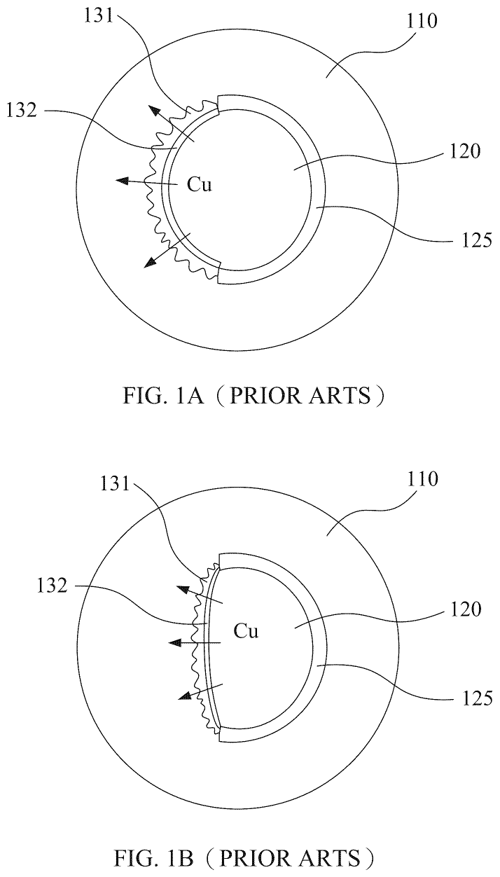

FIG. 2 is a cross-sectional view schematically showing the copper wire after the reflow soldering process.

FIGS. 3A-3C are schematic diagrams showing a soldering method according to an embodiment of the present disclosure.

FIG. 4 is a flowchart of the soldering method according to the embodiment of the present disclosure.

FIG. 5 is a schematic diagram illustrating an electronic component according to an embodiment of the present disclosure.

### DETAILED DESCRIPTION OF PREFERRED EMBODIMENTS

The present disclosure will now be described more specifically with reference to the following embodiments. It is to be noted that the following descriptions of preferred embodiments of this invention are presented herein for purpose of illustration and description only. It is not intended to be exhaustive or to be limited to the precise form disclosed.

The present disclosure provides a solder paste particularly for soldering a copper wire and an associated soldering method, which prevent excessive dissolution of the copper wire into the solder at high temperature, thereby avoiding influence on the mechanical strength and the electrical conductance of the copper wire.

Solder paste is a paste substantially formed by suspending a tin alloy powder in a flux. Common solder pastes include SAC305, SAC307, SnBi, SnBiAg, SnPb, etc. The compositions of the tin alloy powders are shown in Table 1.

TABLE 1

| Solder paste | SAC305 | SAC307 | SnBi | SnBiAg | SnPb |
|---|---|---|---|---|---|
| Alloy | Sn: 96.5 | Sn: 99 | Sn: 42 | Sn: 64 | Sn: 63 |
| composition | Ag: 3.0 | Ag: 0.3 | Bi: 58 | Bi: 35 | Pb: 37 |
| (wt %) | Cu: 0.5 | Cu: 0.7 | | Ag: 1 | |
| Melting | 217-221 | 217-227 | 138 | 178 | 183 |
| point (° C.) | | | | | |

To meet certain specific requirements, such as lowering the eutectic point, increasing the solder joint strength, and improving the wettability, a small amount of metal such as silver, lead, bismuth, antimony, nickel, gold or copper may be added to the tin alloy powder. The present disclosure does not limit the minor metal composition in the tin alloy powder of the solder paste. The tin content of the tin alloy powder is preferably greater than 40 wt %.

The copper powder used in this disclosure has a particle size D₅₀ of 1-50 μm. A copper-added tin-based solder paste is prepared by adding a copper powder to the above-described solder paste or another suitable solder paste in a specific weight ratio and mixing them uniformly, using a syringe to dispense the mixture, and using a degassing machine to degas the dispensed portions. In this way, the copper-added tin-based solder paste with homogeneous mixing of copper powder and tin alloy powder is finally obtained. The added copper powder is dispersed in the flux and does not form an alloy with the tin alloy powder at room temperature, so the added copper powder does not affect the melting point of the original solder paste. The copper-added tin-based solder paste of the present disclosure has a melting point of 130-240° C. For example, different proportions of copper powder are added in SAC305 having a melting point of 221° C. It is observed that the copper-added SAC305 could be melted normally after passing a reflow oven at 230° C. Examples of the copper-added tin-based solder paste prepared according to the present disclosure using SAC305 (86 wt % of tin alloy powder and 14 wt % of flux) are shown in Table 2, wherein the copper powder ratio=copper powder weight/(copper powder weight+tin alloy powder weight).

TABLE 2

| Solder | Tin alloy | Copper | Copper |
|---|---|---|---|
| paste (g) | powder (g) | powder (g) | powder ratio |
| 30 | 25.8 | 1 | 3.73% |
| 20 | 17.2 | 1 | 5.49% |
| 16 | 13.76 | 1 | 6.78% |

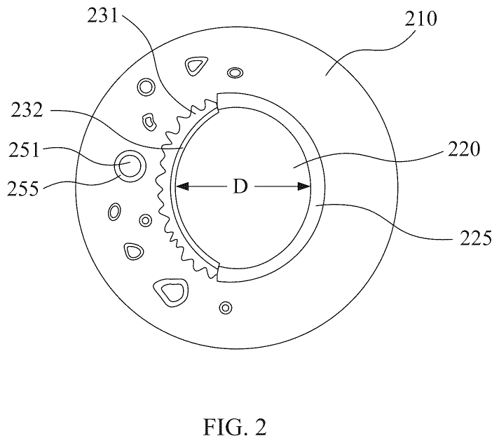

One reflow soldering cycle includes a preheat zone, a thermal soak zone, a reflow zone and a cooling zone. The reflow soldering process at 265° C. using the above-listed copper-added tin-based solder paste with different copper powder ratios and applied to a 33 μm copper wire is repeated and the cross-sections thereof are observed. The structure is shown in FIG. 2. The soldering member 210 covers the copper wire 220 and its insulation layer 225. A Cu₆Sn₅ intermetallic compound layer 231 and a Cu₃Sn intermetallic compound layer 232 are formed between the soldering member 210 and the copper wire 220. In addition, it is observed that copper powder particles 251, having a particle size of 1-50 μm, are distributed within the soldering member 210. The concentration of the copper powder particles 251 in the soldering member 210 varies with the distance from the copper wire 220. Generally speaking, the total volume of the copper powder particles accounting for 0.1-35% of the soldering member is considered to be within the scope of the present disclosure. The copper powder particles 251 are enveloped by the intermetallic compound 255. The composition of the intermetallic compound 255 includes Cu₆Sn₅ and/or Cu₃Sn. The copper powder particles 251 and the surrounding intermetallic compound 255 are both located in the soldering member 210 and do not directly contact the copper wire 220. The average wire diameter D of the copper wire 220 in the samples after each reflow soldering cycle is measured, and the results are shown in Table 3.

TABLE 3

| | |
|---|---|
| Reflow | Copper powder ratio |

| soldering cycle | 3.73% | 5.49% | 6.78% |
|---|---|---|---|
| 1 cycle | 31.2 μm | 30.9 μm | 31.7 μm |
| 2 cycles | 29.8 μm | 31.4 μm | 31.3 μm |
| 3 cycles | 30.4 μm | 29.1 μm | 29.6 μm |
| 4 cycles | 29.1 μm | 28.8 μm | 29.2 μm |
| 5 cycles | 29.1 μm | 29.1 μm | 29.1 μm |
| 6 cycles | 29.5 μm | 28.5 μm | 27.9 μm |

It can be seen that after six reflow soldering cycles, the copper wire 220 can still retain approximately 85-90% of its original diameter D, and thus preserve the mechanical strength and the electrical conductance of the copper wire 220 at the soldering joint. It demonstrates that the addition of copper powder to the solder paste effectively inhibits the copper wire from dissolving in the molten tin. The copper dissolution rate can be described by the Noyes-Whitney equation (Equation (1)) as follows:

$$\frac{d C}{d t} = K \frac{S}{V} ( {C}_{S} - C ) \qquad ( 1 )$$

where:
dc/dt is the copper dissolution rate;
K is the copper solubility coefficient;
S is the surface area of copper in contact with molten tin;
V is the volume of molten tin; and
C_{S} is the saturation concentration of copper in molten tin.

In the reflow soldering process, the added copper powder, rather than the copper wire 220, provides the copper atoms/particles. As a result, the copper concentration in the molten tin near the copper wire 220 increases, resulting in decreasing the driving force for dissolution of the copper particles of the copper wire 220. When the copper powder ratio is sufficient high, the driving force for dissolution of copper particles of the copper wire 220 is greatly reduced, and the wire diameter of the copper wire does not have obvious change even after several reflow soldering cycles.

In addition, the copper powder near the copper wire 220 in the soldering member 210 reacts with the tin atoms/particles of the soldering member 210 to continuously thicken the Cu₆Sn₅ intermetallic compound layer 231, thereby reducing the tin concentration of the soldering member 210 near the copper wire 220 and suppressing the rate of forming the intermetallic compound layer resulting from the reaction between the tin atoms/particles and the copper atoms/particles from the copper wire 220.

Furthermore, when the tin concentration near the copper wire 220 decreases, that is, the copper concentration increases, the concentration gradient of copper content at the interface between the copper wire 220 and the soldering member 210 is reduced. According to Fick's first law of Equation (2), the driving force enabling the copper atoms/particles of the copper wire 220 to diffuse into to the soldering member 210 is also reduced.

$$\vec{J} = - D \cdot ∇ C \qquad ( 2 )$$

where:
[symbol] is the diffusion flux; and
VC is the concentration gradient of copper component.
   Thus, when the copper concentration of the soldering member 210 near the copper wire 220 is much higher than 0.5% for SAC305 or 0.7% for SAC307, the diffusion of copper atoms/particles from the copper wire 220 into the solder member 210 can be effectively suppressed.

As the copper atoms/particles and the tin atoms/particles of the soldering member 210 react to from the Cu₆Sn₅ intermetallic compound and the Cu₃Sn intermetallic compound, the thicknesses of the Cu₆Sn₅ intermetallic compound layer 231 and the Cu₃Sn intermetallic compound layer 232 gradually increase. Their respective melting points are 415° C. and 676° C., and they do not melt during the reflow soldering process. The intermetallic compound layers 231 and 232 can effectively prevent the copper atoms/particles on both sides from passing and diffusing therethrough, thereby maintaining the wire diameter D of the copper wire 220. Especially, when the amount of copper atoms relative to tin atoms exceeds a certain ratio, alloying does not occur, and intermetallic compounds are formed instead.

As described above, when the Cu₆Sn₅ intermetallic compound transforms into the Cu₃Sn intermetallic compound, Kirkendall voids are generated due to the volume shrinkage. In addition, the Cu₆Sn₅ intermetallic compound tends to form a hexagonal phase (n) at temperatures above 186° C., and tends to form a monoclinic phase (n′) at temperatures below 186° C. Therefore, upon cooling from a high temperature to a low temperature, phase transformation occurs along with volume shrinkage, resulting in the formation of fine voids. These fine voids formed due to the phase transformation upon the cooling are smaller than the Kirkendall voids. Both types of voids affect the dissolution and alloying behavior of the copper particles and the tin particles.

The above description illustrates the mechanism with the presence of the copper powder and explains how the copper-added tin-based solder paste of the present disclosure can mitigate the thinning of the copper wire 220 after the reflow soldering process. However, when the copper powder is added too much, a greater amount of intermetallic compound is formed in the soldering member 210 so as to reduce the strength of the solder joint. Therefore, an optimal copper powder ratio is needed to balance the requirements of preventing the dissolution of the copper wire 220 and maintaining the strength of the solder joint. In one embodiment, after six reflow soldering cycles using the SAC305 solder paste with different copper powder ratios and applied to 33 μm copper wires, the average wire diameter D of the copper wire 220 in the samples is measured, and the results are shown in Table 4.

TABLE 4

Copper powder ratio

| | 0% | 0.6% | 1.8% | 3% |
|---|---|---|---|---|
| Average wire | 5.72 | 20.60 | 24.66 | 26.58 |
| diameter (μm) | | | | |

| | Copper powder ratio | | |
|---|---|---|---|
| | 3.73% | 5.49% | 6.78% |
| Average wire | 29.45 | 28.48 | 27.89 |
| diameter (μm) | | | |

It is observed that adding a small amount of copper powder can already achieve significant improvement. When the copper powder ratio exceeds approximately 3.5%, the residual wire diameter does not have noticeable change. Accordingly, it is estimated that an applicable copper powder ratio is 0.2-20%, a more preferable copper powder ratio is 0.5-10%, and a most preferable copper powder ratio is 3.5-5.5%.

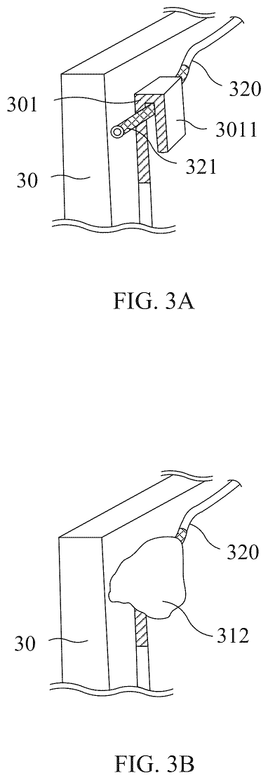

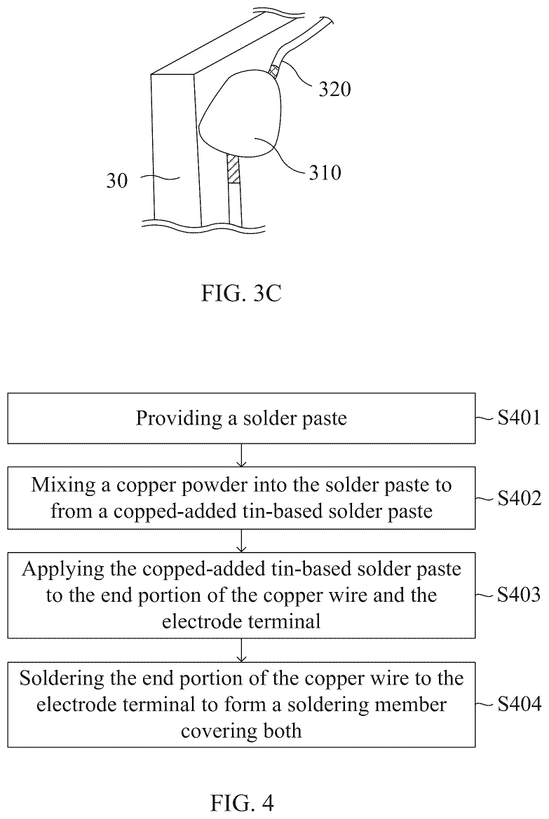

Please refer to the schematic diagrams of FIGS. 3A-3C and the flowchart of FIG. 4, which illustrate the soldering method of the present disclosure. FIG. 3A shows a core element 30 of an electronic component having an electrode terminal 301. The soldering method of the present disclosure is applied to solder the electrode terminal 301 and an end portion 321 of the copper wire 320. If the end portion 321 is provided with an insulation layer, the insulation layer is entirely or partially stripped to expose the conductor of the copper wire. The electrode terminal 301 may include a clamping part 3011 configured to clamp and secure the end portion 321. However, the present disclosure is not limited to the secure means.

First, a solder paste is provided (step S401). The solder paste may be any of the aforementioned solder paste or any other applicable solder paste. The solder paste includes a tin alloy powder and a flux wherein the tin alloy powder is suspended in the flux. The solder alloy powder includes more than 40 wt % of tin and further includes one or more minor metals, such as silver, lead, bismuth, antimony, nickel, gold or copper. A copper powder is then mixed into the solder paste to form a copper-added tin-based solder paste (step S402). The weight of the copper powder accounts for about 0.2-20% of the total weight of the metal powder weight, that is, the

$$copper powder ratio = \frac{copper powder weight}{copper powder weight + tin alloy powder weight} = 0.2 - 20 \% .$$

The copper powder and the solder paste are physically mixed, without affecting the melting point of the solder paste. For example, the melting point of the obtained copper-added tin-based solder paste is 130-230° C. Next, as shown in FIG. 3B, the copper-added tin-based solder paste 312 is applied to the end portion 321 of the copper wire 320 and the electrode terminal 301 of the core element 30 (step S403). Subsequently, a reflow soldering process (step S404), including a preheat zone, a thermal soak zone, a reflow zone and a cooling zone, is performed. The temperature of the reflow zone is slightly higher than the melting point of the copper-added tin-based solder paste, ensuring that the copper-added tin-based solder paste in the molten state does not damage the electronic component. Finally, the copper-added tin-based solder paste 312 solidifies to form a soldering member 310, covering the end portion 321 of the copper wire 320 and the electrode terminal 301, thereby fixing the relative position between the end portion 321 and the electrode terminal 301, and completing the electrical connection, as shown in FIG. 3C.

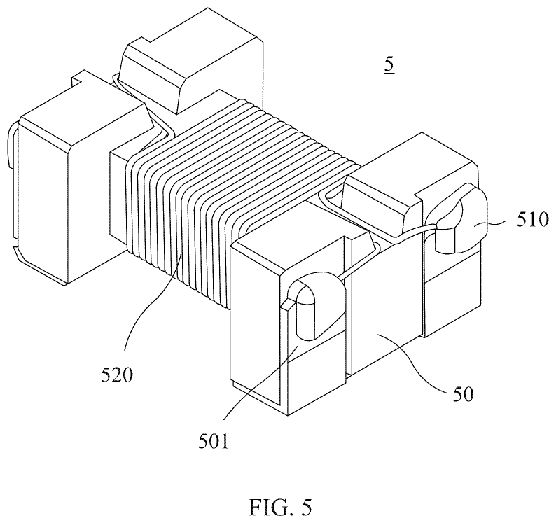

The copper-added tin-based solder paste and the soldering method of the present disclosure can be applied to any electronic component having a solder joint. Please refer to FIG. 5, which is a schematic diagram illustrating an electronic component according to an embodiment of the present disclosure. In this diagram, the electronic component is a coil component 5, and a copper coil 520 is wound around the core element 50. By using the copper-added tin-based solder paste and the soldering method of the present disclosure, a solder joint 510 is formed to solder one end of the copper coil 520 to the electrode terminal 501 of the core element 50 to achieve electrical connection. Although this embodiment is illustrated with the coil component 5, the present disclosure does not limit the actual form of the electronic component.

According to the copper-added tin-based solder paste, the soldering method, and the electronic component formed thereby of the present disclosure, copper loss in the copper wire during the reflow soldering process can be reduced. Instead, the copper powder added to the solder paste reacts with the tin component. Thus, the wire diameter of the copper wire can be substantially maintained, preventing deterioration of the mechanical strength and the electrical conductance of the copper wire at the solder joint.

While the disclosure has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An electronic component having at least a solder joint, comprising:
a core element having thereon an electrode terminal;
a copper wire, an end portion of which is in contact with the electrode terminal; and
a soldering member, covering the end portion of the copper wire and the electrode terminal to form the solder joint electrically connecting the copper wire to the electrode terminal, wherein copper powder particles enveloped in an intermetallic compound are distributed within the soldering member, and the copper powder particles have a particle size ranging from 1 μm to 50 μm.

2. The electronic component according to claim 1, wherein a volume concentration of the copper powder particles in the soldering member is within a range of 0.1% to 35%.

3. The electronic component according to claim 1, wherein the soldering member is formed by a reflow soldering process, comprising melting a copper-added tin-based solder paste covering the end portion of the copper wire and the electrode terminal of the core element and cooling the copper-added tin-based solder paste to form the soldering member, the copper-added tin-based solder paste comprising a tin alloy powder and a copper powder mixed in a flux.

4. The electronic component according to claim 3, wherein the copper-added tin-based solder paste has a copper powder ratio of 0.2% to 20%, and the copper powder ratio is defined as:
$$\frac{copper powder weight}{copper powder weight + tin alloy powder weight} .$$

5. The electronic component according to claim 3, wherein the tin alloy powder comprises more than 40 wt % of tin.

6. The electronic component according to claim 1, wherein the intermetallic compound enveloping the copper powder particles comprises Cu₆Sn₅ or Cu₃Sn.

7. The electronic component according to claim 1, wherein an intermetallic compound layer is formed between the copper wire and the soldering member to inhibit the copper wire from dissolving in the soldering member.

8. The electronic component according to claim 7, wherein the intermetallic compound layer comprises Cu₆Sn₅ or Cu₃Sn.

9. The electronic component according to claim 1, wherein the electronic component is a coil component, the copper wire is a copper coil wound around the core element, the electrode terminal comprises a clamping part for clamping an end portion of the copper coil, and the soldering member covers the clamping part of the electrode terminal and a clamped portion of the copper coil.

10. A copper-added tin-based solder paste, comprising:
a tin alloy powder;
a copper powder; and
a flux,
wherein a copper powder ratio is within a range of 0.2% to 20%, and the copper powder ratio is defined as:
$$\frac{copper powder weight}{copper powder weight + tin alloy powder weight} .$$

11. The copper-added tin-based solder paste according to claim 10, wherein the tin alloy powder comprises more than 40 wt % of tin.

12. The copper-added tin-based solder paste according to claim 11, wherein a composition of the tin alloy powder comprises silver, lead, bismuth, antimony, nickel, gold or copper.

13. The copper-added tin-based solder paste according to claim 10, wherein the copper powder has a particle size D₅₀ ranging from 1 μm to 50 μm.

14. The copper-added tin-based solder paste according to claim 10, wherein the copper-added tin-based solder paste has a melting point in a range of 130° C. to 230° C.

15. A soldering method for soldering a copper wire to an electronic component, comprising steps of:
providing a solder paste formed by suspending a tin alloy powder in a flux;
mixing a copper powder into the solder paste to form a copper-added tin-based solder paste; and
using the copper-added tin-based solder paste to solder an end portion of the copper wire to an electrode terminal of the electronic component by a reflow soldering process to form a soldering member covering the end portion of the copper wire and the electrode terminal, thereby forming a solder joint electrically connecting the copper wire and the electrode terminal in the electronic component,
wherein the copper-added tin-based solder paste has a copper powder ratio of 0.2% to 20%, and the copper powder ratio is defined as:
$$\frac{copper powder weight}{copper powder weight + tin alloy powder weight} .$$

16. The soldering method according to claim 15, wherein the copper powder has a particle size D₅₀ ranging from 1 μm to 50 μm.

17. The soldering method according to claim 15, wherein the tin alloy powder comprises more than 40 wt % of tin, and the tin alloy powder further comprises silver, lead, bismuth, antimony, nickel, gold or copper.

18. The soldering method according to claim 15, wherein copper powder particles enveloped in an intermetallic compound are formed and distributed in the soldering member after the reflow soldering process, and the intermetallic compound comprises Cu₆Sn₅ or Cu₃Sn.

19. The method according to claim 15, wherein an intermetallic compound layer is formed between the copper wire and the soldering member to inhibit the copper wire from dissolving in the soldering member, and the intermetallic compound layer comprises Cu₆Sn₅ or Cu₃Sn.
